(19) United States
(12) Patent Application Publication
(10) Pub. No.: US 2022/0390278 A1
(43) Pub. Date: Dec. 8, 2022

(54) SPECTRAL ANALYSIS VISUALIZATION SYSTEM AND METHOD

(71) Applicant: TELLSPEC, LTD., London (GB)

(72) Inventors: Isabel De Oliveira Correa, London (GB); Diogo Barros, London (GB); Rafael Queirós, London (GB)

(73) Assignee: TELLSPEC, LTD., London (GB)

(21) Appl. No.: 17/341,008

(22) Filed: Jun. 7, 2021

(51) Int. Cl. G01J 3/02; G01N 21/31; G01N 21/01; G01J 3/42; G06N 20/00; H04L 29/08

(52) U.S. Cl. CPC G01J 3/0275; G01N 21/3103; G01N 21/01; G01J 3/42; G06N 20/00; H04L 67/12; G01N 2021/0143; G01N 2021/0181; G01J 2003/283

(57) ABSTRACT

A system includes a processor receiving spectrometer data representative of a scanned sample and generated by a spectrometer and a cloud server including a server processor. The server processor receives the spectrometer data generated by the spectrometer from the processor, analyzes the spectrometer data, identifies, based on a machine learning application, one or more unique characteristics of the spectrometer data which uniquely identifies the scanned sample and provides to the processor data representative of a graphical display, which includes an indication of whether or not the scanned sample includes the one or more unique characteristics of the spectrometer data.

### BACKGROUND

### 1. Technical Field

This disclosure relates generally to a processing system for transferring spectrometry data received from a spectrometer to a multicomputer data network, such as a computing cloud, for analysis and visualization of the spectrometry data. Additionally, the processing system disclosed herein receives spectrometry data and uses machine learning to develop a testing model for use in predictive analysis of future spectroscopy samples. This testing model may be used for a variety of specific applications but may be deployed for instant use by a host of users across the world to do, for example, counterfeit analysis. The testing model may be constantly updated and refined by machine learning based on the results of the counterfeit analysis to enhance the accuracy of the model, identify new counterfeited items, products, or packaging, and new sources of the same.

### 2. Description of the Related Art

Spectrometers and spectrographs were developed to determine the type and contents or components of a particular spectrographic sample, which initially was typically in the field of minerals and mining, particularly for gold. For the purpose of this disclosure spectrometers are intended to be a broad term, encompassing spectrographs and spectroscopes, and any other device that determines the contents of a sample on an atomic or molecular level based on, for example, atomic bonds between atoms or molecules by the means of electromagnetic light dispersed across the electromagnetic spectrum. Spectrometers, much like X-ray and Gamma ray technology, grew out of a need to determine the contents of a sample without either destroying the sample or going through the time-consuming process of analyzing the constituent elements of a sample through chemical processes. Spectrometers today are remarkably accurate using light sources of various wavelengths to determine the contents of a sample.

Every atomic element on the periodic table of elements responds differently to different types of light. However, every atom that is the same as another atom will respond the same way to different types of light. As an example, iron atoms will respond to light in a way that is different from carbon atoms or oxygen atoms the same way chemical bonds that make up ingredients in products will absorb light and exhibit an expected behavior. But every iron atom will respond to the same type of light in the same way allowing scientists to extract patterns from this behavior. One measure of such light exposure is referred to as “absorbance” which is a measure of how much light is absorbed by an atom, a chemical bond, or a sample compared against a reference whose absorbance is known. The absorbance for each known periodic element, chemical bond or sample is known and distinguishable by spectrometers. Thus, through light exposure, a spectrometer may provide data which indicates a relative percentage composition of a particular sample. For example, a representative sample of gold ore sampled by a spectrometer may contain 10% gold, 35% calcium, 35% carbon, 10% lead, and 10% hydrogen while a gold bar sampled by the spectrometer may identify 99.99% gold and 0.001% lead (e.g., 24 kt 0.9999 fine gold), the same way a food sample can be constituted by 40% water, 30% carbohydrates, 20% protein and 10% fat.

At least some, if not most, current spectrometers are capable of accurately ascertaining concentrations of small amounts of a certain type of material or ingredient. However, management and deployment of such data has been far more limited by both available processing power and the speed at which new spectrometry data can be obtained. The analysis of data generated by spectrometers has been, historically, largely done on a personal computer or by local area networks. Analysis of data generated by one or more spectrometers has not taken advantage of cloud computing, machine learning and/or blockchain methods to enhance the processing power available to analyze data generated by the one or more spectrometer, and ensure its authenticity and traceability through a distributed network of nodes that verifies a set of clauses in order to corroborate the legitimacy of a given process or chain of events. Such processes or events may be the different physical and spatial locations a given good had gone through since it was produced. Conventionally, analysis of data generated by one or more spectrometers has been a slow process which is unable to respond to constantly evolving threats, such as counterfeiting or adulteration.

Spectroscopic analysis has been used to identify one or more traits of a sample in order to include or disinclude that sample from a potential group. For example, mankind has used lead since very early in its development. Lead mined throughout the world is typically different from mine to mine based on the constituent particles that are not lead within the lead that is retrieved from the mine. Today, through spectroscopic analysis, a piece of ancient lead can be analyzed to determine which other constituent particles it contains and, therefore, which mine the lead came from, which can help in archeological discovery. However, in order to properly perform the spectroscopic analysis, each of the known constituent particles and their relative amounts in a sample are typically tested individually to compare with known samples. Thus, lead may be tested for the amount of tin in a sample and then be retested for an amount of zinc in the sample, and then, by process of elimination, the source of that lead sample can be determined.

Such a process is extremely time-consuming and given that the problem is often not that the spectrometer lacks the sensitivity to properly ascertain the contents of a sample, even in minute concentrations given the complex chemical information present in the sample spectrograph. The problem is that the ability to analyze the spectroscopic data is very complex and time consuming, requires experts to interpret the collected data and reference data inherent to the scanned samples, as well as a high processing power that may not be available to the user.

Accordingly, given that a result from a spectrographic analysis has been difficult, time-consuming to obtain, especially for what may concern the specific amount of the components in a sample or whether or not one sample belongs to a specific class of materials, substances or products based on the presence of unique identifying characteristics. Accordingly, a purpose of this disclosure is to describe a system that includes a visualization engine (for the spectra obtained, data collected, insights on the machine learning model developed such as the hyperparameters used or prediction models developed with or without hyperparameter optimization) which displays the results obtained from using machine learning algorithms of different classes ranging from classification to regression tasks and of multiple samples at the same time. This disclosure also provides a system that offers a graphical user interface for visually developing, testing, validating, and deploying machine learning predictive model for spectrographic samples.

This disclosure provides solutions to provide more accurate data analysis using machine learning techniques for analyzing spectrometer data. Classical statistical modeling was designed for data with few input variables and small sample sizes. In spectroscopy applications, however, analysis may require a larger number of input variables and associations between those variables which, in turn, requires a robust model that captures these more complex relationships. Machine learning techniques provide these advantages over less classical statistical inferences. No prior art systems have provided analysis of spectrometer data based on machine learning models built from spectrometer data to test, validate, and deploy machine learning models accessible to multiple users around the world, simultaneously, in synchronization, anywhere, and in real time.

### SUMMARY

A system includes a processor receiving spectrometer data representative of a scanned sample and generated by a spectrometer and a cloud server including a server processor. The server processor receives the spectrometer data generated by the spectrometer from the processor, analyzes the spectrometer data, identifies, based on a machine learning application, one or more unique characteristics of the spectrometer data which uniquely identifies the scanned sample and provides to the processor data representative of a graphical display, which includes an indication of whether or not the scanned sample includes the one or more unique characteristics of the spectrometer data. Further disclosed herein is a method which includes receiving, by a processor, spectrometer data representative of a scanned sample. The method further includes analyzing, by the processor, the spectrometer data. The method further includes identifying, by the processor, and based on a machine learning application, one or more unique characteristics of the spectrometer data which uniquely identifies the scanned sample by the spectrometer. Finally, the method includes providing, by the processor, data representative of the scanned sample by the means of the graphical display. This data covers a large set of properties of the scanned samples ranging from the raw spectrographic data to processed data corresponding on insights about the scanned sample that can be related to a bigger universe of samples or different databases.

### BRIEF DESCRIPTION OF THE DRAWINGS

The accompanying drawings illustrate various embodiments of the spectral analysis visualization system and method.

FIG. 1 illustrates an exemplary multicomputer network system that provides spectral analysis visualization.

FIG. 2 illustrates an exemplary cloud computing data structure for providing spectral analysis visualization.

FIG. 3 illustrates an exemplary graphical user interface for the development and training of a machine learning model for spectral analysis visualization.

FIG. 4 illustrates an exemplary graphical user interface for illustrating a spectral analysis visualization.

FIG. 5 illustrates another exemplary graphical user interface for illustrating a spectral analysis visualization.

FIG. 6 illustrates another exemplary graphical user interface for illustrating a spectral analysis visualization.

FIG. 7 illustrates a method for training a machine learning model and performing predictive analysis with a testing model.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the system disclosed herein. While the techniques and embodiments will primarily be described in context with the accompanying drawings, those skilled in the art will further appreciate that the techniques and embodiments may also be practiced in other similar systems.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

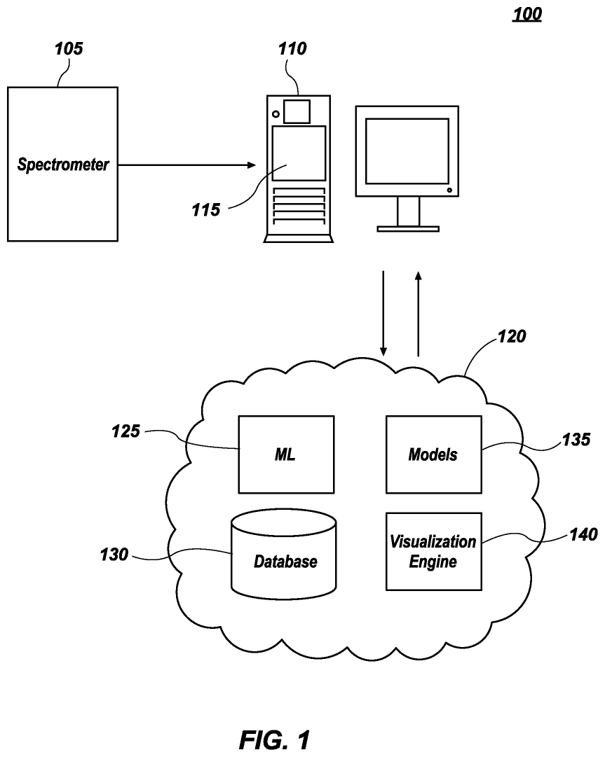

FIG. 1 presents an exemplary multicomputer network system 100 that provides spectral analysis visualization. Multicomputer network system 100 includes a spectrometer 105 which may be implemented as a spectroscope, spectrograph, or any other device which determines a relative concentration or amount of a particular periodic element, molecule(s), or chemical bonds expressed or present in a spectrographic sample using any technique whether based on optical spectrometers, mass spectrometers, or electron spectrometers, or other spectrometers known in the art. Spectrometer 105 may be implemented with any type of sensor for analyzing a sample. For example, spectrometer 105 may be implemented with a near infrared sensor and emitter. Other types of sensors and emitters that are based on infrared, gamma rays, X-rays, or other wavelengths of light may also be used within spectrometer 105 alone or in any combination. Spectrometer 105 may collect one or more data elements from a spectrographic sample. Data elements collected by the spectrometer may be representative of a spectrographic sample and include data representative of the constituent material of the sample in either atomic or molecular form. Data elements may further contain information about the spectrographic sample, such as absorbance, transmittance, mass, or reflectivity, and any other data format that is conventionally associated with spectrographic samples for determining and distinguishing one element or molecule from another within the sample.

Multicomputer network system 100 implements a user device 110. User device 110 may be a computing device that includes a processor 115. Examples of computing devices include desktop computers, laptop computers, tablets, game consoles, personal computers, notebook computers, and any other electrical computing device with access to processing power sufficient to interact with multicomputer network system 100. User device 110 may include software and hardware modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within user device 110 may be used to execute the various methods or algorithms disclosed herein independent of or in coordination with other devices disclosed herein. For example, a training model, which will be discussed below may preferably be created on user device 110 by a user and uploaded to cloud server 120. However, a training model may also be made by accessing cloud server 120 and creating the model directly on cloud server 120.

A user of user device 110 may use user device 110 to train a predictive model or to test a sample with a testing model, using the techniques described below, directly or by interfacing with one or more cloud servers. A predictive model, also referred to as analyzing, training or machine learning model, may be provided with data that has a known characteristic or a set of known characteristics intrinsic to the scanned sample as a result of its fundamental interaction with the used type of light. The analyzing model may be subjected to various statistical analyses, which will be discussed below, to produce a result that reflects the known characteristic or set of known characteristics. A characteristic may include one or more spectrometer data readings, one or a plurality of wavelengths of the electromagnetic spectrum which responded to the spectrometer when sampling an item, or any data received from the spectrometer that can be used to uniquely identify a composition of a scanned sample (e.g., a regressive analysis) or uniquely identify whether or not a sample is consistent with other samples (e.g., a classification analysis). For example, a particular supplier of a plant based products may suspect that the supplier's products are being counterfeited. The supplier of the plant based products may provide samples for spectrographic analysis in order to provide information about the characteristics of the supplier's products which can, in turn, be used to build a predictive model for classification (e.g., whether or not a scanned product is or is not counterfeit). In this case, one characteristic of the products may be that a content of a certain molecule or chemical bond is always below a certain threshold across the statistically significant representation of the supplier's products. Or another characteristic of the supplier's products may be that a content of a certain molecule or chemical bond is always above a certain threshold across the statistically significant representation of the supplier's products. Another example of a characteristic of the supplier's products may be a concentration of a particular element, molecule or chemical bonds exceeding or being below a certain threshold. A user of user device 110, preferably, may make models based on these characteristics that identify a scanned sample as being counterfeit or not counterfeit.

This description is not limited to identifying counterfeit or non-counterfeit items. Other examples may include training models, based on unique characteristics, to identify products that have been adulterated, faked, passed off, sabotaged, variations in alterations of a supplier's products, testing for product quality control, or testing for the lack of certain concentration levels in order to optimize the final product. For example, if baby formula is tested only for whether or not it has high protein content in the formula, analysis or quality control may not detect that unscrupulous actors may have cut or thin the formula with fillers (e.g., use the contents of one can of formula in other cans with fillers to cause the can to appear to be full and, in this way, turning one can of formula into a plurality of cans of saleable formula). Thus, a testing model that identifies more than a single characteristic, such as protein content, may be necessary to detect by spectrometer scan that the formula has been cut or thinned. The use of multiple characteristics in an analysis may be referred to as a multiple dimension analysis.

As several samples of data are collected a training model may be developed in conjunction with cloud server 120, which will be further described below, that may use a multitude of dimensions—ranging from one to the total number of dimensions acquired—for the analysis of other characteristics or to train the model to predictively identify the intrinsic properties of a new scanned sample. For example, the training model may be developed from 100 or more samples of the supplier's products which are used to train the model to predict whether or not a particular spectrographic sample is or is not produced by the supplier. Since the 100 or more samples are all known to be the supplier's products, the accuracy of the model may be ascertained, and if necessary, refined, to produce a model that accurately predicts, to the desired level, whether or not a new sample is consistent with the supplier's products. At this point, the training model may become a testing model, as will be described below, and used for testing samples with unknown characteristics. In this manner, the supplier may test suspected counterfeit items with spectrometer 105 and determine whether or not those suspected counterfeit items are or are not counterfeit items. Further, if multiple counterfeiting operations exist, visualization of the model can show common characteristics among the samples in, for example, a scatter plot, that clearly delineate sources of the counterfeit items from both the supplier and other counterfeiters.

A predictive model is typically developed by a user using a graphical user interface on user device 110 while computationally intense review and the application of machine learning is performed by cloud server 120. Cloud server 120 may be implemented as one or more server computing devices. Cloud server 120 may include cloud computers, super computers, mainframe computers, application servers, catalog servers, communications servers, computing servers, database servers, file servers, game servers, home servers, proxy servers, stand-alone servers, web servers, combinations of one or more of the foregoing examples, and any other computing device that may be used to execute perform machine learning, train training models, test testing models, implement a visual representation of the stored data or get insights on the use of the predictive model either in a production or deployment setting. The one or more server computing devices may include software and hardware modules, sequences of instructions, routines, data structures, display interfaces, and other types of structures that execute server computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within one or more server computing devices may be used to execute the various methods or algorithms disclosed herein, and interface with user device 110 and cloud database 130.

In one embodiment, cloud database 130 includes one or more volatile and non-volatile memory devices, storage units, and non-transitory computer-readable storage media. Cloud database 130 maintains data related to training data models and testing models from spectrometer data. For example, cloud database 130 may maintain spectrometer data created by spectrometer 105, may maintain data for machine learning application 125, store training and testing models 135, and provide data storage for visualization engine 140. Cloud database 130 may also exchange stored data with user device 110 via processor 115 and cloud server 120.

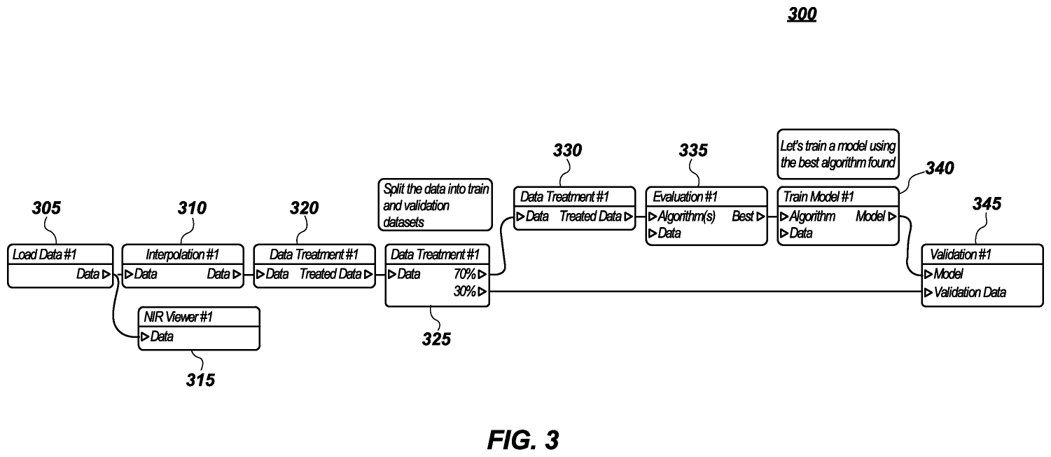

In one example, a user of user device 110 may define an algorithm for developing a training model, which will be discussed with respect to FIG. 3 below, which may be defined by the cloud server 120 and stored as a model 135. The user may also provide spectrographic data representative of one or more spectrographic samples, to cloud database 130. Cloud server 120 may apply a machine learning application 125 to model 135. For example, machine learning application 125 may analyze spectrometer data from one or more spectrographic samples to find common characteristics among all of the samples. The machine learning application 125 may identify certain compositions, substances, concentrations, atoms of periodic elements, molecules, chemical bonds, or intrinsic matter-light interactions that are indicative of characteristics of known samples. The machine learning application 125 may further identify algorithms for finding common characteristics among all of the samples. In other words, machine learning application 125 may apply regression algorithms which identify how much of a constituent material is contained in a sample (e.g., how much nicotine in a tobacco sample, how much citric acid in a fruit sample, how much THC content in cannabis, etc.). Machine learning application 125 may also apply classification algorithms which identify whether or not a sample belongs to a particular group (e.g., are the items counterfeit or not counterfeit?). In one example, machine learning application 125 may analyze the spectrographic data of different samples of illicit items, such as cocaine or heroin, for example. Based on the known point of origination for a sample of cocaine, for example, machine learning application 125 may be able to distinguish characteristics across a number of dimensions, unique spectrographic markers that uniquely identify that particular drug as coming from a single source using regressive or classification type algorithms. Once those unique markers are identified, cocaine, for example, from other sources, may be spectrographically tested to identify unique spectrographic markers which identify that particular drug as coming from another source by machine learning application 125. These unique spectrographic identifiers may be exported from the training model into a testing model 135 for analysis of cocaine of unknown origins. In this manner, after some testing, a number of cocaine producers may be identified, a relative location of those producers may be identified based on the unique spectrographic characteristics of the sample, and the supply line of the cocaine for a particular producer can be tracked as new samples are discovered in various places.

Machine learning application 125 may also use regressive or classification type algorithms to identify whether or not certain products are counterfeit and the location and evolution of those products in trade channels. For example, cloud server 120 may be accessed by a number of users using a user interface device 110 and provided with spectrometry data from spectrographic samples of the suspected counterfeit products. Machine learning application 125 may identify whether or not the products are counterfeit, for example, by applying a classification type algorithm which compares the suspected counterfeit product to a known sample which is not counterfeit. If the suspected products are counterfeit, a user may cause cloud server 120 to perform another machine learning based algorithm to identify a number of characteristics of the counterfeit good product to develop a new algorithm for identifying those particular counterfeit products among a group of other counterfeited products. By identifying unique characteristics of a plurality of different counterfeit products and using the locations of each of the users, a “heat map” of illicit products may be developed which identifies not only where the most illicit products are found in the world, but where along the trade channels the illicit products are found in real time. At least in some cases, trade routes and locations may be identified which may lead directly to a location where the counterfeit products are produced. Since data may be collected in real time by individual users in synchronized cooperation across the world in cloud server 120, trade channels and trade routes may be identified quickly by scanning products being offloaded from ships, determining where those ships were loaded, and then inspecting products at the locations where they are loaded onto ships, for example. Various customs agencies across the world may further use spectrometer 105 to determine whether or not products passing through customs are counterfeit and, if they are, work to seize the counterfeit products from entry into that particular country.

In one example, a particular tobacco producer may produce a tobacco product which may be known to be counterfeited products. The tobacco producer may obtain samples from across the world by synchronized cooperation of individual users of a user device 110 to identify counterfeited products by using a spectrometer to sample suspected counterfeit products, uploading that information through user device 110 to cloud server 120, and applying a predictive model to the data. Cloud server 120 may determine, in real time, that counterfeit products from one source are being produced in India, for example, being refined in Bangladesh, and being shipped mainly to Germany and Brazil while another source is producing products in India, refining the products in India, and being shipped to different areas of the United Kingdom. Thus, in a very brief period of sampling, the tobacco producer may identify a number of producers of the counterfeited products and where those counterfeit products flow into commerce. Such information, especially produced in real time by cloud server 120, may be invaluable for identifying and preventing the sale of counterfeited products. Further, a heat map, which may be a visualization of counterfeited products, may identify areas where the counterfeiting is most severe and likely locations where the products may be interdicted.

It should be noted that during spectrometer scanning of unknown products, unexpected data may be identified. This unexpected data may be indicative of a new unknown source of counterfeit items, a variation in a known source of counterfeit items or other characteristics of the counterfeit items. For example, a nicotine level of a counterfeit tobacco product may be higher than other sources but may also contain a higher level of aromatic hydrocarbons than a non-counterfeit sample, which may be unknown to a particular predictive model, though known to be counterfeit. Accordingly, the predictive model may be constantly updated by machine learning application 125 to retrain the model to detect an unknown counterfeit product with other characteristics than those used to identify other known counterfeit products. As each sample is scanned and the data is provided to the testing model then deployed into a predictive model, the model becomes more robust as it iteratively discovers new or potentially new characteristics of counterfeit items, thus causing the testing model to effectively learn from new data and improve in its ability to predict whether or not a particular scanned sample of a product is from a counterfeit or non-counterfeit product.

Visualization engine 140 may translate the number of dimensions of characteristics that uniquely identify a particular set of scanned samples into a graphical user element. The graphical user element may be viewed as a two-dimensional or three-dimensional representation of the set of scanned data to facilitate human understanding. The technique of “Principal Component Analysis”, may be used to reduce the dimensionality of the characteristic of the data. Other similar or equivalent techniques known to those of ordinary skill in the art for reducing the dimensionality of the characteristic of the data may also be used. In the particular example discussed here, if there are 25 different cocaine producers, for example, visualization engine 140 may display up to the number of characteristics of each sample (e.g., the spectrum) in a scatter plot which represents samples from each of the 25 different cocaine producers. The scatter plot may or may not include data about the samples such as reference data and intrinsic data. The scatter plot may show, for example, 25 individual clusters of samples with different spectrographic analysis showing that there are 25 sources for the cocaine tested in this particular example.

To visualize the reference label (i.e., lab results) and the intrinsic label (name, class of sample etc.) several type of charts may be used, including scatter plots, bar charts, line charts, and any other type of chart known in the art.

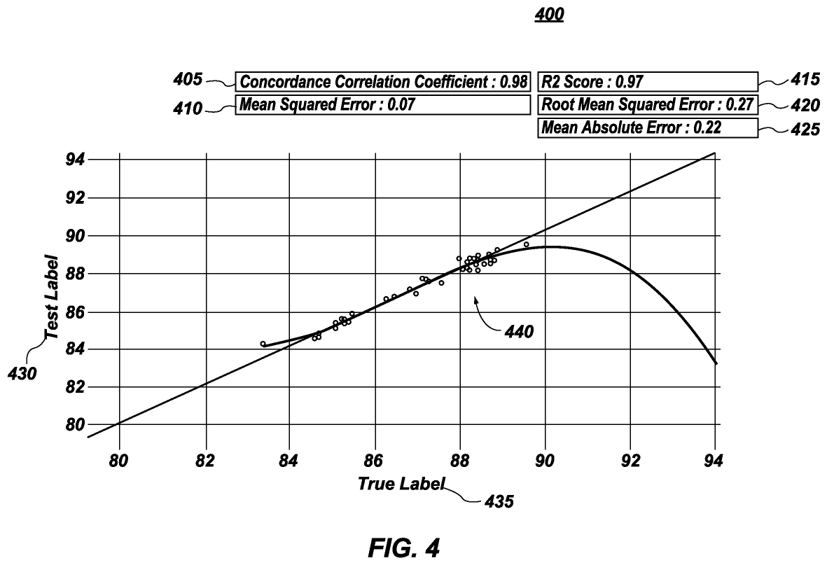

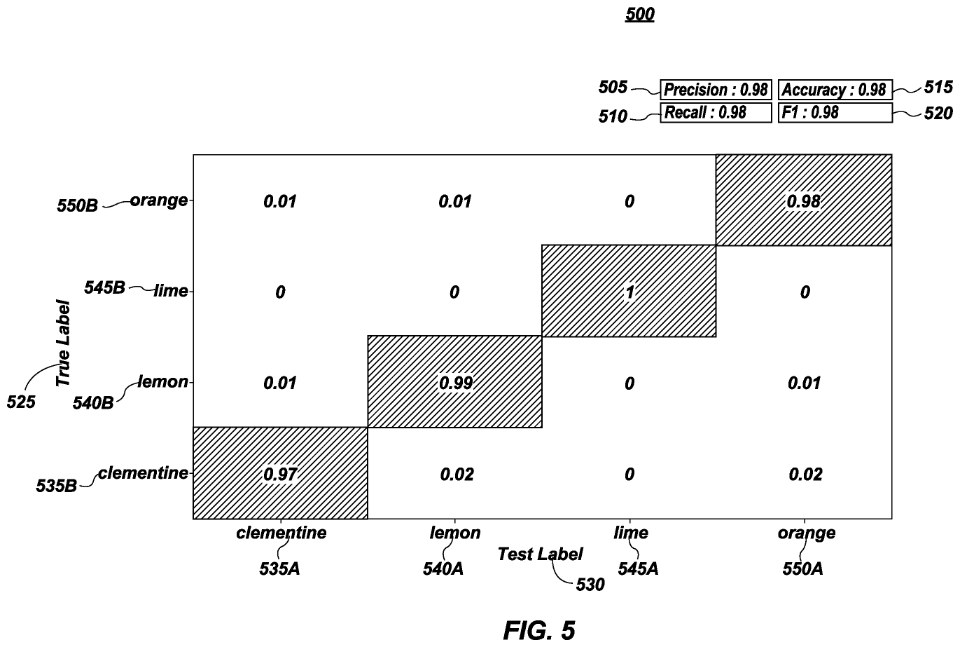

Cloud server 120 may exchange information with user device 110 while performing the computationally intense analysis in minutes or less depending on the complexity of the model. Cloud server 120, using machine learning application 125 and visualization engine 140 to identify accurate models and apply testing can reduce analysis times from days to minutes. Further, cloud server 120 providing visualization engine 140 allows for a much faster recognition of the metrics of the model. Various visualizations are possible from visualization engine 140 which may all be referred to as visualizations. For example, displaying a result of “counterfeit” or “not counterfeit” may be a simple visualization of a result of the spectral analysis of sampled products. Other visualizations may include graphical visualization of the full spectrum or set of spectra or 3 dimensions, graphical visual representations of labels and reference data, and visualization of model validation results for calibration curves (shown in FIG. 4) and confusion matrices (shown in FIG. 5).

In one embodiment, user device 110 may access cloud server 120 via an Internet connection to one or more server computing devices. Any suitable Internet connection may be implemented including any wired, wireless, or cellular based connections. Examples of these various Internet connections include implemented using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a 5G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication between user device 110, and cloud server 120.

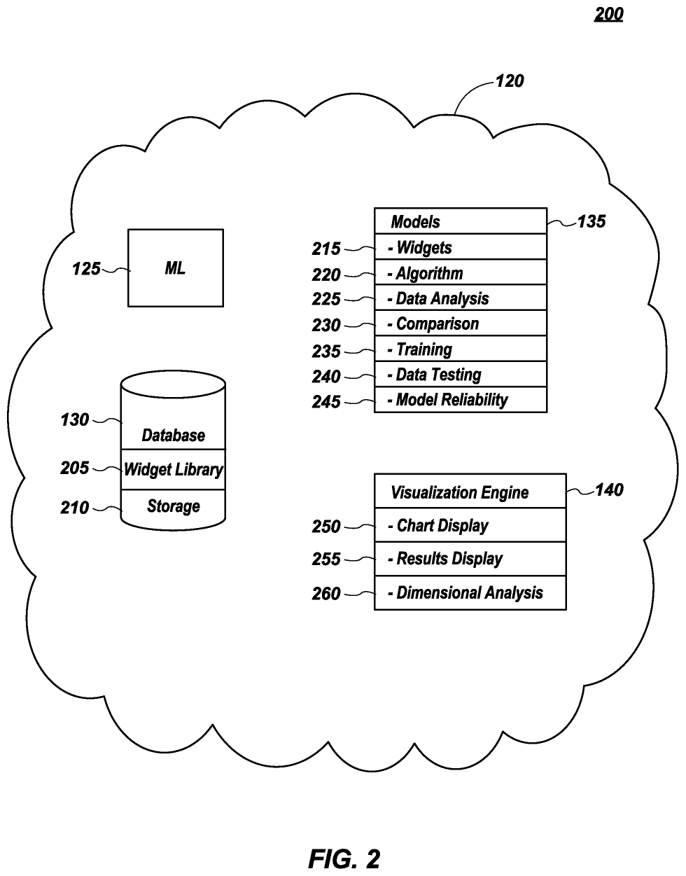

FIG. 2 illustrates an exemplary cloud computing data structure for cloud server 120 providing spectral analysis visualization. As discussed above, cloud server 120 includes a machine learning application 125, a database 130, a models application 135, and a visualization engine 140.

Machine learning application 125 may analyze spectrometer data provided from user device 110 and spectrometer 105 for unique characteristics that identify a product or a set of products. Machine learning application 125 may provide those unique characteristics to a training model in models application 135 to train the model to accurately identify the unique characteristics in the spectrometry data. Once the unique characteristics of the spectrographic analysis of the product or set of products is known, the training model may be expanded to include other samples of products from other known sources and identify unique characteristics of those products in contrast to the unique characteristics of previously sampled products. Once the training model is accurate to the degree desired, cloud server 120 may provide a predictive analysis that a particular product is or is not associated with a certain provider, from a certain area, or has a certain quality, as will be discussed below.

Database 130 may provide a widget library 205. Widget library 205 includes a plurality of user interactive elements which all perform unique analysis on spectrometry data. Widget library 205 may include mathematical regressions, evaluations, data treatments, interpolations, validations, and visualizations as discrete tasks in an algorithm created by a user of user device 110 shown in FIG. 1, to train a model. Widgets will be discussed more with respect to FIG. 3. However, a library of functions associated with training a model, such as widget library 205 may be stored in database 130. Alternatively, user device 110 may contain storage for widget library 205 as well. Database 130 may also provide the necessary memory storage 210 for storing spectrometry data, various models, visualizations, and any other data that requires storage in computer server 120.

Model application 135 may include widgets 215 which are implemented from the widget library 205 in the particular model to be trained or tested. A model incorporates a plurality of widgets 215 to create an algorithm 220 which performs data analysis 225. Based on the algorithm 220, a comparison or predictive determination is made, depending on whether the particular model is a training model or a testing model, which indicates that a particular product does include the unique identifying characteristics to be included in a group, a particular product includes other unique identifying characteristics to be included in another group, or lacks the unique identifying characteristics to be included in any known group. Model 135 may be trained as a training model 235 or as a data testing model 240 based on whether or not the model has been determined to be accurate or reliable 245 for the intended purpose of model 135.

Visualization engine 140 provides a chart display functionality 250, a results display functionality 255, and a dimensional analysis 260. Chart display functionality 250 provides the ability for visualization engine 140 to interpret results from the model and transform those results into a visual chart representation of those results, including scatter plots, bar charts, line charts, and any other type of chart known in the art, at the discretion of the model creator. Results displaying functionality 255 may show pure results in a set of metrics such that each result may be accessible for review. However, visualization engine 140 may transform the set of numbers into a graph which enhances human understanding of the underlying result data. There are other cases, where the data is complex and requires a number of underlying characteristics to be shown, which is not perceptible to human beings. Thus, visualization engine 140 may interpolate data from a number of underlying characteristics or dimensions and render those characteristics in a 2-dimensional or 3-dimensional visual representation that shows how each sample correlates to the other samples from the spectrometry data. Visualization engine 140 may provide graphical displays of the analyzed spectrometry data using one or more different charts or views as dictated by the data for illustrating the results of the data in a way that facilitates human comprehension of the results.

FIG. 3 illustrates an exemplary graphical user interface 300 for a training model for spectral analysis visualization. Graphical user interface 300 includes a plurality of widgets 305-345 which are stored in a library as either on user device 110, shown in FIG. 1 or in database 130, shown in FIG. 1 and FIG. 2. Widgets 305-345 each perform different functions, which will be discussed below. Widgets 305-345 are merely representative of widgets stored in a widget library and may include other processes or analysis tools which are not specifically illustrated in FIG. 3. Widgets 305-345 may be color coded to specifically identify a type of function performed by the widgets. For example, a step that involves importing data may be color coded yellow while a step that involves visualizing data may be color coded green. Further, a step that involves a pretreatment or interpolation of data may be color coded blue while a step that involves machine learning may be color coded red. A model training step may be color coded teal. Color coding each of the widgets based on function is useful for identifying errors in analysis design while providing a simple efficient way to display the function that is next to be performed.

As shown in FIG. 3, graphical user interface 300 may illustrate an analysis of an amount of octane in gasoline, for purposes of example and explanation. Virtually any analysis of any spectrographic data may be performed using widgets 305 organized in a meaningful way to produce a meaningful result. Graphical user interface 300 illustrates the creation of a training model for identifying octane in gasoline from spectrographic data of gasoline samples.

In the case of graphical user interface 300, the analysis is performed by a user pulling widgets from the widget library in a meaningful way to test the amount of octane in gasoline. Each widget is selected by the user from the library and may be visually dragged from the library and dropped into a workflow, as shown in FIG. 3. The analysis begins by loading data at widget 305 of spectrographic data obtained from a spectrometer and uploaded to cloud 120 by user device 110, shown in FIG. 1. The spectrographic data may be interpolated at widget 310 and, in parallel, be visualized by a near infrared viewer provided by visualization engine 140, shown in FIG. 1. The user may create connections between each widget to perform the analysis.

Here, the electromagnetic type of light used can be displayed and the visualization providing the user with an initial view of the raw data collected via a spectrometer before any other analysis steps are taken. Once the data is interpolated, a data treatment widget 320 may be used to identify errors or inconsistencies in the raw data and ensure that the results are sufficient for further analysis, scale the data, smooth the data, and normalize numeric values. At widget 325, the data may be split in a 70/30 ratio in order to train the model with some of the data and validate the model with the remaining data, as will be discussed below. 70% of the data split from widget 325 may be applied to a regression widget 330 for statistical analysis of the spectrographic data to identify unique or consistent characteristics among each of the samples for which spectrographic data is being analyzed. Any statistical methodology may be applied to the data by a regression widget 330 or other widget to analyze the spectrographic data. Indeed, it is optimal for many different types of statistical regression or mathematical evaluation techniques to be applied to determine which of them produce the best identification of the unique characteristics of a particular sample. At evaluation widget 335, the applied statistical regressions or mathematical evaluations may be evaluated to determine which of the regression or mathematical evaluations produced the best result in identifying the unique characteristic or set of characteristics of the particular sample. The best result is used to train a model at widget 340. The trained model at widget 340 may then receive the remaining 30% of the data split at widget 325 to validate the results of the data and ascertain the quality of the training model. If the training model has an adequate statistical reliability, the training model may be used as a testing model, as will be discussed below.

FIG. 4 illustrates an exemplary graphical user interface 400 for illustrating a model validation result as a spectral analysis visualization. FIG. 4 illustrates the result of operations of widgets 305-345 shown in FIG. 3. As shown in FIG. 4, graphical user interface 400 provides a plurality of indicators, such as indicator 405 which is a concordance correlation coefficient of 0.98, an indicator 410 which is a mean squared error of 0.07, an indicator 415 which is a R² score of 0.97, an indicator 420 which is a root mean squared error of 0.27, and an indicator 425 which is a mean absolute error of 0.22. Without a full statistical analysis, indicators 405-425 indicate that the training model shown graphical user interface 300 of FIG. 3 is accurate in identifying the octane of a sample of gasoline.

Graphical user interface 400 further illustrates a graphical representation 440 of the known “true label” 435 on the X axis of graph 440 against the “test label” 430 on the Y axis of graph 440. For example, once the training model was trained in FIG. 3 with 70% of the available data, the remaining 30% of the data is tested against the model to determine the accuracy of the model. Each dot in graph 440 represents a spectrographic sample of gasoline and shows a correlation between a low of approximately 83 octane and a high of approximately 89 octane. Each of the samples are shown to be accurate to within an absolute error of 0.22, as shown in indicator 425. Graphical user interface 400 illustrates a successful model for predicting the octane level in gasoline in future samples of gasoline and the model generated in widget 340 of graphical user interface 300 may be used successfully as a testing model or deployed into a predictive model when used in the field by different end users.

FIG. 5 illustrates another exemplary graphical user interface 500 for illustrating a model validation result as a spectral analysis visualization of spectrographic data from fruit. Using the techniques above for training a model, a training model has produced graphical user interface 500 as another type of visualization by visualization engine 140, shown in FIG. 1, that identifies different characteristics of fruit, such as juiciness, citric acid content, and brix (sugar levels). FIG. 5 illustrates a validation that the training model has successfully identified each type of fruit based on the provided characteristics.

Graphical user interface 500 includes an indicator 505 for precision which is 0.98, an indicator 510 for recall which is 0.98, an indicator 515 for accuracy of 0.98, and an indicator 520 for the statistical representation F1 which is 0.98. This illustrates that the system can correctly predict that a particular spectrographic sample is one of an orange, lime, lemon, or clementine with 98% accuracy based on three different characteristics, such as juiciness, citric acid content, and brix.

Graphical user interface includes a graph identified by a “Y” axis “true label” 525 and an “X” axis “test label” 530 which shows the relative accuracy of identifying each specific fruit against each other fruit based on the provided characteristics. As shown, row 535B, and column 535A show that the model accuracy identifying a clementine was 0.97 when compared with a lemon (0.01), a lime (0.0), and an orange (0.01). Column 540A and row 540B illustrate that the model accuracy of identifying a lemon was 0.99 when compared with a clementine (0.02), a lime (0.0), and an orange (0.01). Column 545A and row 545B illustrate that the model accuracy of identifying a lime was 1.0 with no errors as compared with a clementine, a lemon, and an orange. Column 550A and row 550B show that the model accuracy identifying an orange was 0.98 when compared with a lime (0.0), a lemon (0.01), and a clementine (0.02).

The overarching point of this particular analysis is that system 100, shown in FIG. 1, may use spectrometer data to identify unique characteristics across a number of dimensions, train models to identify them based on unknown spectrometer data, and predict with accuracy what the sample is based on the spectral analysis of the sample. Applications for this type of analysis are virtually endless and include identifying counterfeit items, sources of counterfeit items, octane in gasoline, milk analysis, types, and sources of illicit items, viruses contamination, soil element concentrations, cannabinoids levels in products, drug levels in blood, food analysis for consumers, supermarkets, purchasers, or farms, and a host of other applications.

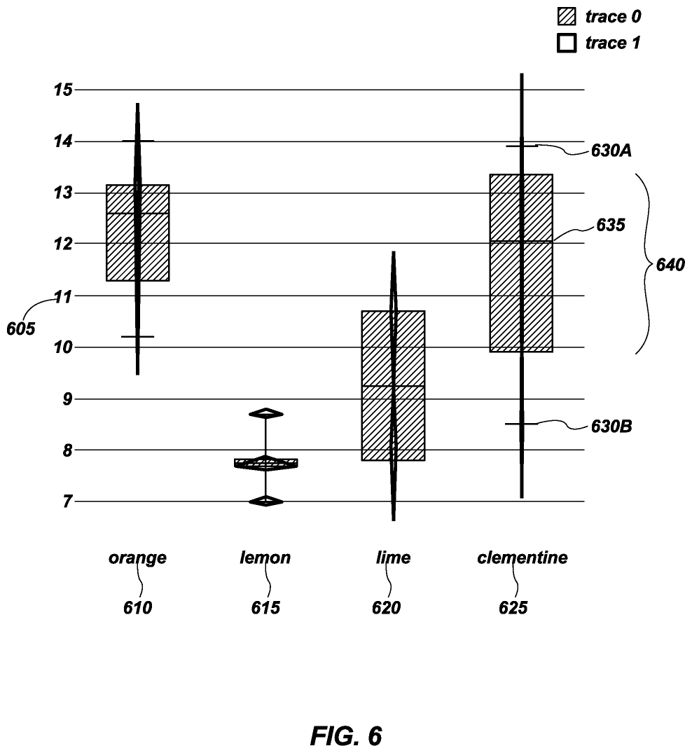

FIG. 6 illustrates another exemplary graphical user interface 600 for illustrating a reference data distribution analysis as a spectral analysis visualization. Graphical user interface 600 provides an illustration of brix concentration 605 in different fruits such as orange 610, lemon 615, lime 620, and clementine 625. Thus, in graphical user interface 600 each single characteristic for defining fruit is visualized by visualization engine 140, shown in FIG. 1. As illustrated in FIG. 6, each one of orange 610, lemon 615, lime 620, and clementine 625 include an absolute maximum brix 630A and an absolute minimum brix 630B for the spectrometer data for each of the samples of a particular fruit. Also shown is an average brix 635 and a median range for brix of each fruit 640. It should be noted that each of these elements is shown with respect to clementine 625 but apply to each one of orange 610, lemon 615, and lime 620.

From graphical user interface 600, spectrometer data shows that lemons 615 have the least relative and absolute concentration of brix. Limes have a wider variation of brix with the minimum and maximum brix establishing the median range for brix in limes. Very few of lemons 615 are as sweet (e.g., have the same levels of brix) as even the tartest limes. On the whole, oranges 610 are sweeter than clementines 625 with the exception that the sweetest clementines 625 are sweeter than the average orange 610. Using this data, machine learning application 125 may begin to create rules for identifying a brix characteristic for each one of orange 610, lemon 615, lime 620, and clementine 625. Similar analyses can be performed with respect to a content of citric acid and juiciness, for example, to create a model that may successfully and predictively identify fruit based on spectroscopic analysis. This data may be invaluable to supermarkets, produce inventory purchasers, farms, and consumers to identify when the fruits are at their peak for consumption.

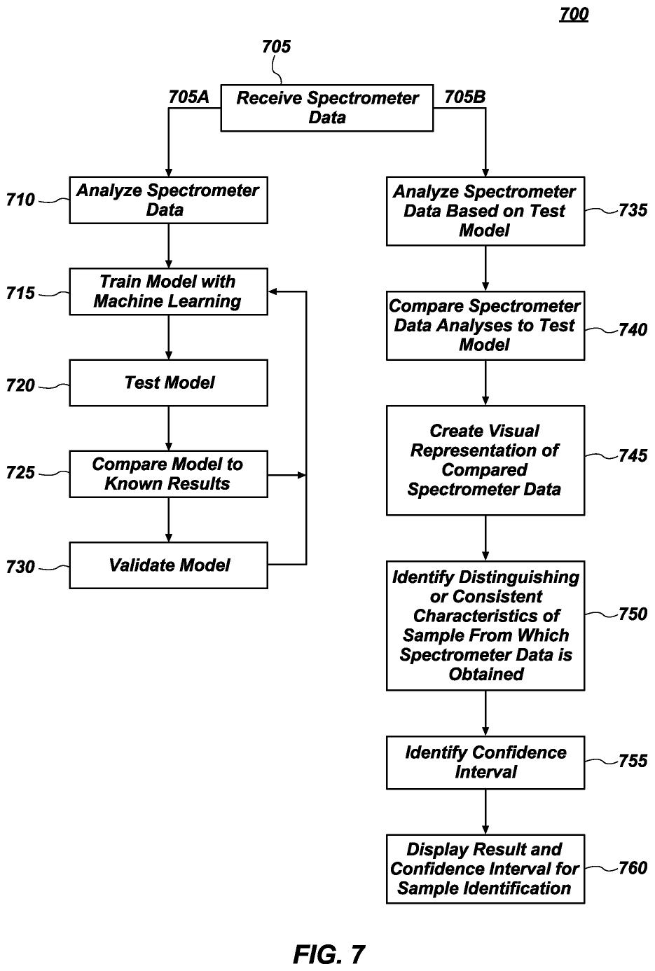

FIG. 7 illustrates a method 700 for training a training model and performing predictive analysis with a testing model. Method 700 begins with receiving spectrometer data obtained from a spectrometer at step 705. Depending on the desires of the user, a training model may be generated with the spectrometer data at step 705A, or the spectrometer data may be tested using a testing model at step 705B. As previously discussed, a training model may be created by a statistical algorithm to identify unique characteristics of the sampled products for distinguishing predictive markers while a testing model may be used to sample unknown products and based on the identified unique characteristics in the unknown products, predict an identification of the products.

In generating a training model at step 705A, spectrometer data may be analyzed at step 710 using various techniques as shown and described with respect to FIG. 3. Statistical and mathematical applications may be used to treat and interpolate the data in a manner that causes a machine learning application in a cloud server 120, shown in FIG. 1, to identify unique characteristics of known sampled products. At step 715, a model may be trained with the unique characteristics of the scanned sample identified with the machine learning application to identify unknown scanned samples. At step 720 the training model may be tested by comparing the model to known, ground truth results at step 725. If the training model tests successfully to known results, the training model may be validated by applying new or other un-analyzed data to the training model at step 730. Should the training model fail, or provide an accuracy of identification that is below acceptable standards for the particular analysis, the training model may be returned from either step 725 or step 730 to step 715 for retraining of the model. This process may be repeated until an acceptable accuracy is produced by the training model. Once this point is reached, the training model may be a testing model.

At step 705B, a testing model may be used to identify unknown products. To clarify, the products used in training the training model may preferably be products of similar types to the unknown products. For example, if the training model is generated based on fruit identification, the known samples may be other types of fruit. In other words, the known sampled products and the unknown sampled products may be “like” products (e.g., fruit vs. fruit, tobacco vs. tobacco, fish vs. fish, gasoline vs. gasoline, etc.).

At step 735, spectrometer data generated by a spectrometer may be analyzed based on the test model, or with respect to the test model. At step 740, optionally, the spectrometer data analysis may be compared to the test model to create a visual representation of compared spectrometer data at step 745. In other words, a processor in cloud server 140, shown in FIG. 1, may compare the spectrometer data of an unknown product to like spectrometer data of a known product, and create a visual representation of the compared spectrometer data using visualization engine 140 (e.g., a data processor) to both create a visual representation in a number of dimensions and then interpolate that data into a 2 dimensional or 3 dimensional rendering of the data to facilitate human understanding of the data. It is also conceivable that a test model may return a final result for display on a screen of user device 110, for example, and a confidence level as a visualization of the result of the application of a test model to a sample (e.g., if the result is a result of a classification model, the resulting visualization may be an indication that a product is “counterfeit” or “not counterfeit or of not legitimate origin.).

At step 750, cloud server 120 may identify distinguishing or consistent characteristics of the spectrometer data in the test model as compared to the unknown spectrometer data sample to identify the unknown sample. At step 755, an optional confidence interval may be generated and provided as an indicator as shown in FIGS. 4 and 5. Finally, a result may be displayed with an optional confidence interval or threshold at step 760 which is an identification of the products based on the spectrographic analysis, based on whether or not the model is a regression model or a classification model. The identification of the products may be that the product in this particular sample is a juicy lime, or cocaine from Columbia, or fish with higher than expected single and/or multiple chemical contamination, or cannabis with a specific THC content, the product is illicit, or the product is counterfeit based on a level of nicotine in the product, or a host of other identifications. In other words, the identification of the products may include more than indicating that the product is a lime and may indicate that the product is a lime with a higher than average brix concentration or gasoline with a high amount of octane, or laundry with a high COVID-19 contamination level, or a host of other identifications.

Using the foregoing system and techniques, provides significant advantages over conventional systems. Multiple characteristics of products may be tested simultaneously using a graphical user interface that is interactive with library-based widgets. Further, the characteristics of the products identified from spectrometer data may be identified as unique characteristics, which facilitate identification of similar products from different sources. A machine learning application may identify unique characteristics of certain products and facilitate accurate identification of like products that are of unknown origin.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a processor receiving spectrometer data representative of a scanned sample and generated by a spectrometer;
a cloud server including a server processor which:
receives the spectrometer data generated by the spectrometer from the processor,
analyzes the spectrometer data,
identifies, based on a machine learning application, one or more unique characteristics of the spectrometer data which uniquely identifies the scanned sample, and
provides to the processor data representative of a graphical display, which includes an indication of whether or not the scanned sample includes the one or more unique characteristics of the spectrometer data.

2. The system of claim 1, wherein the processor provides a graphical user interface on a user device for interaction with the user.

3. The system of claim 2, wherein the processor provides access to a widget library which provides tools for analyzing spectrometer data.

4. The system of claim 3, wherein the widget library contains one or more visualization widgets.

5. The system of claim 4, wherein the widget library contains one or more data treatment widgets.

6. The system of claim 5, wherein the widget library contains one or more machine learning widgets.

7. The system of claim 6, wherein the widget library contains one or more model training widget.

8. The system of claim 3, wherein each widget in the widget library is color coded in the graphical user interface by function.

9. The system of claim 1, wherein identifying, based on a machine learning application, one or more unique characteristics of the spectrometer data which uniquely identifies the scanned sample includes an identification of the one or more unique characteristics.

10. The system of claim 1, further comprising training a training model to identify the one or more unique characteristics in the scanned sample.

11. The system of claim 1, further comprising applying the training model as a testing model to predict whether or not an unknown scanned sample shares the one or more unique characteristics.

12. The system of claim 1, wherein graphical display representative of whether or not the scanned sample includes the one or more unique characteristics of the spectrometer data is displayed by the processor on the user device.

13. The system of claim 1, wherein the server processor is part of a cloud computing system which includes a database, one or more training or testing models, and a visualization engine.

14. A method, comprising:
receiving, by a processor, spectrometer data representative of a scanned sample and generated by a spectrometer;
analyzing, by the processor, the spectrometer data;
identifying, by the processor and based on a machine learning application, one or more unique characteristics of the spectrometer data which uniquely identifies the scanned sample, and
providing, by the processor, data representative of a graphical display which includes an indication of whether or not the scanned sample includes the one or more unique characteristics of the spectrometer data.

15. The method of claim 14, further comprising:
providing, by the processor, a graphical user interface which includes access to one or more widgets from a widget library.

16. The method of claim 15, wherein the widgets provide tools for analyzing spectrometer data.

17. The method of claim 14, further comprising identifying the scanned sample as being authentic.

18. The method of claim 14, further comprising identifying the scanned sample as being counterfeit.

19. The method of claim 14, further comprising:
training, by the processor, a training model to identify the one or more unique characteristics of the spectrometer data using spectrometer data representative of known scanned samples.

20. The method of claim 19, wherein the training model is used as a testing model to identify the same one or more unique characteristics of the spectrometer data using spectrometer data representative of unknown scanned samples.
